(19) United States
(12) Patent Application Publication
(10) Pub. No.: US 2008/0013783 A1
(43) Pub. Date: Jan. 17, 2008

(54) Image forming apparatus and image processing method

(75) Inventors: Yasushi Yamade, Tokyo (JP); Yoshio Miyamoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/649,302

(22) Filed: Jan. 4, 2007

(30) Foreign Application Priority Data
Jul. 11, 2006 (JP) 2006-190603

(51) Int. Cl. G06K 9/00

(52) U.S. Cl. 382/100

(57) ABSTRACT

Disclosed is an image forming apparatus, including: a scanner unit to read an original image to generate image data; and a control unit to judge whether there is a security watermark in the original image or not based on the image data, and to prohibit reducing the number of pixels of the image data to a predetermined value or less when the control unit recognizes a presence the security watermark in the original image.

### CROSS REFERENCE TO RELATED APPLICATION

The present U.S. patent application claims a priority under the Paris Convention of Japanese patent application No. 2006-190603 filed on Jul. 11, 2006, which shall be a basis of correction of an incorrect translation.

### BACKGROUND

1. Field of the Invention

The present invention relates to an image forming apparatus and an image processing method which are suitable for reading an original image including a security watermark to generate permanent or temporal image data.

2. Description of Related Art

In a recent information society, the reexamination of the security for electronic information has been strongly requested, and security guard concerning the Internet such as virus guard, access limitation and the like is busily performed. On the other hand, it is the present state of things that the security of paper documents has not been advanced yet, the trouble that secret information is copied to be taken out to the outside has occurred.

In such a situation, a technique called as “security watermark” has been developed as a technique for preventing forgery copying of the paper documents. The security watermark is to print a concealed text 102 and a pattern 103 in the background of a copy 101 as shown in FIG. 8 when an original 100 is copied. According to the security watermark technique, when the original 100 is copied, the concealed text 102 looms out from the pattern 103 in the copy 101. Thereby, it can be easily judged that the copy 101 is a forgery copy.

JP 10-236045A (see paragraphs 0015-0030 and the like) discloses a further high technique for preventing the forgery copying. To put it concretely, the background region of a printed matter is divided into two regions of a copy image and a moiré pattern, the display modes of which differ from each other, and at least one of the copy image and the moiré pattern is copied according to the height of resolution. As a result, whatever resolution copying is performed at, an original and the copy thereof can be clearly distinguished, and the forgery copying can be surely prevented.

However, in the technique described in the JP 10-236045A, it becomes difficult to discriminate the text in the copy image portion (corresponding to the concealed text 102 in FIG. 8) in a copy if the resolution is set to be low at the time of copying an original image. Thus, there is the possibility of resulting in the impossibility of effectively preventing the forgery copying owing to the disappearance of even the moiré pattern portion if a second, a third and so forth of the copying are repeated.

### SUMMARY

It is one of objects of the present invention to prevent the forgery copying surely.

According to a first aspect of the invention, an image forming apparatus comprises: a scanner unit to read an original image to generate image data; and a control unit to judge whether there is a security watermark in the original image or not based on the image data, and to prohibit reducing the number of pixels of the image data to a predetermined value or less when the control unit recognizes a presence the security watermark in the original image.

Preferably, the apparatus further comprises: a display panel unit to display the presence of the security watermark in the original image.

Preferably, the apparatus further comprises: a printer unit to record an image on a recording medium based on the image data to output the recording medium as a copy.

Preferably, the apparatus further comprises: a setting unit to set resolution, wherein the control unit prohibits reducing the number of pixels of the image data to the predetermined value or less independent of the resolution set by the setting unit when the control unit recognizes that there is the security watermark in the original image.

Preferably the apparatus further comprises: a setting unit to set a zoom ratio of copying, wherein the control unit prohibits reducing the number of pixels of the image data to the predetermined value or less independent of the zoom ratio set by the setting unit when the control unit recognizes that there is the security watermark in the original image.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing the schematic configuration of an image forming apparatus 1;

FIG. 2 is a view showing the external appearance of an operation panel unit 10;

FIG. 3 is a view showing an external appearance (first message) of a display panel unit 20;

FIG. 4 is another external appearance (second message) of the display panel unit 20;

FIG. 5 is a view showing a further external appearance (third message) of the display panel unit 20;

FIG. 6 is a flow chart showing each step of processing of an image processing method according to a first embodiment with time;

FIG. 7 is a flow chart showing each step of processing of an image processing method according to a second embodiment; and

FIG. 8 is a view for describing security watermark printing.

### DETAILED DESCRIPTION OF THE PREFERRED EMBODIMENTS

In the following, the best modes for carrying out the present invention are described with reference to the attached drawings. However, the scope of the invention is not limited to the shown examples.

### First Embodiment

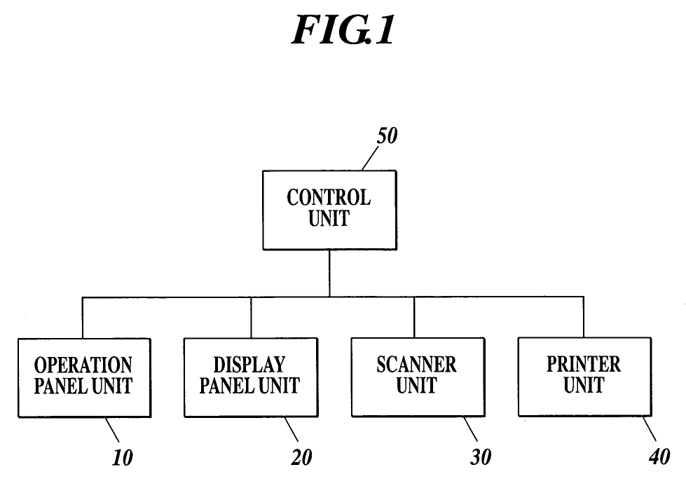

As shown in FIG. 1, an image forming apparatus 1 according to the present embodiment is composed of an operation panel unit 10, a display panel unit 20, a scanner unit 30, a printer unit 40, a control unit 50 and the like. The image forming apparatus 1 has the configuration in which the operation panel unit 10, the display panel unit 20, the scanner unit 30 and the printer unit 40 are severally connected with the control unit 50.

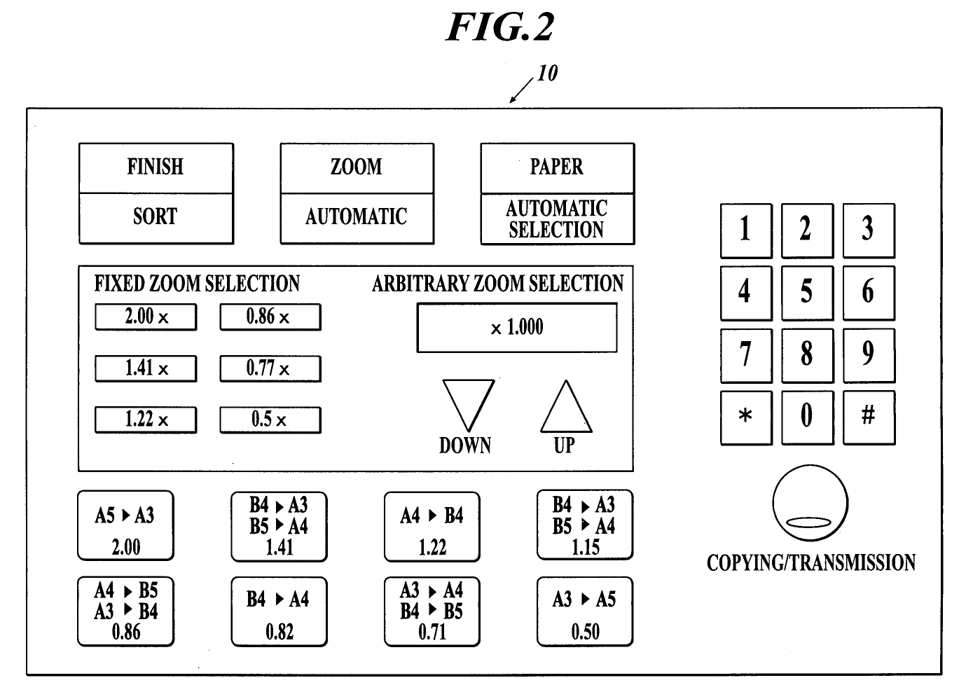

The operation panel unit 10 is a section composed of a plurality of operation buttons for setting various conditions at the time of copying an original image, as shown in FIG. 2. The image forming apparatus 1 is configured so that the condition based on the operation button may be transmitted to the control unit 50 as a signal when a user depresses an operation button in the operation panel unit 10. In particular, the image forming apparatus 1 is configured to be able to set the resolution and the zoom ratio of an original image at the time of copying by an operation of the operation panel unit 10 (see a later description).

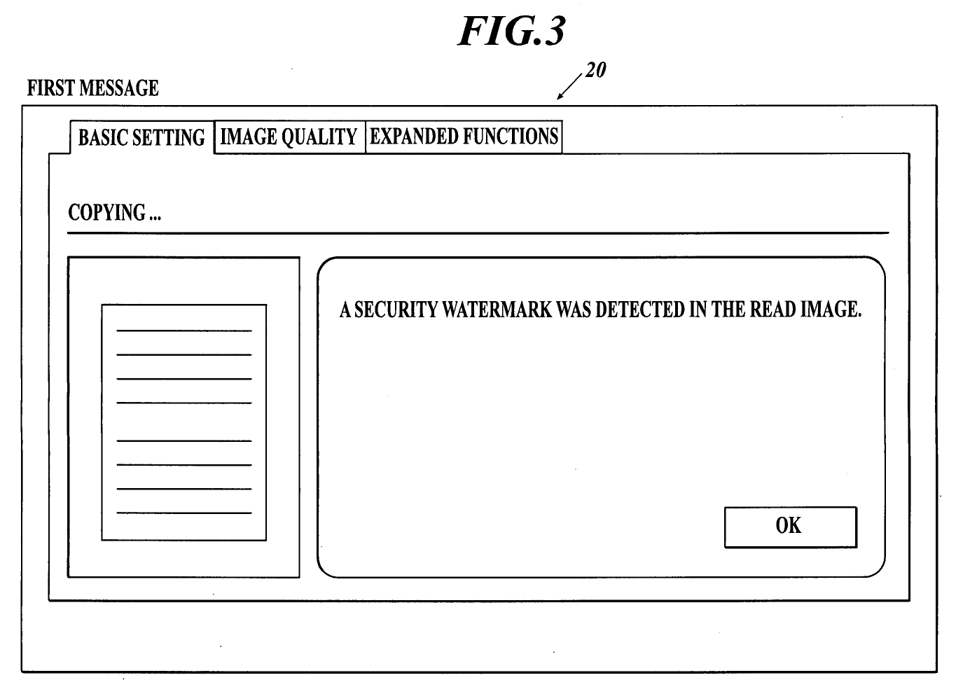

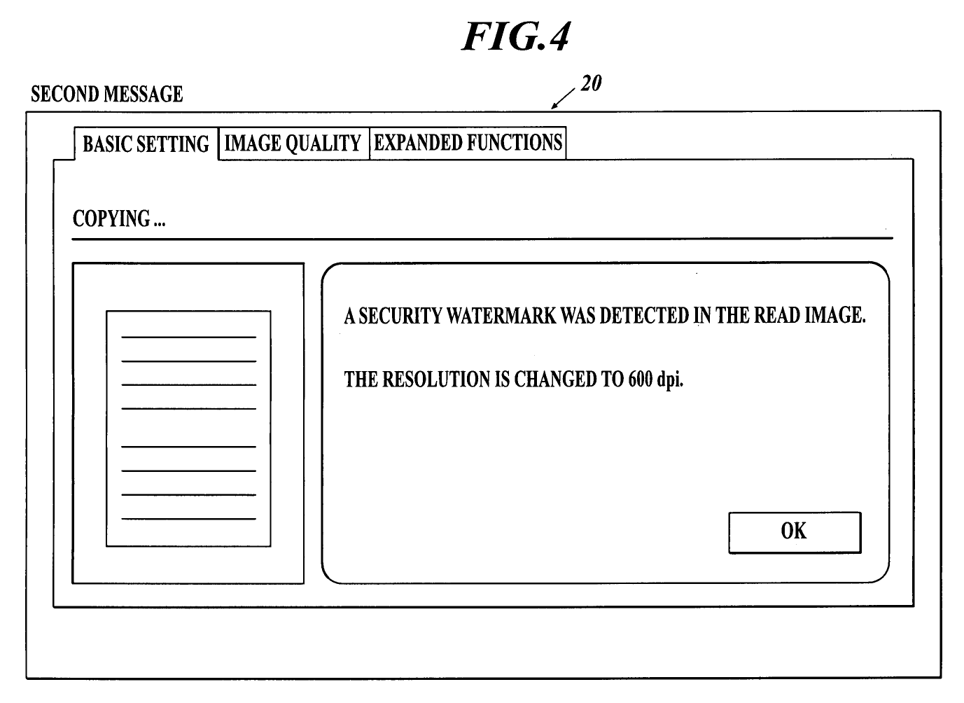

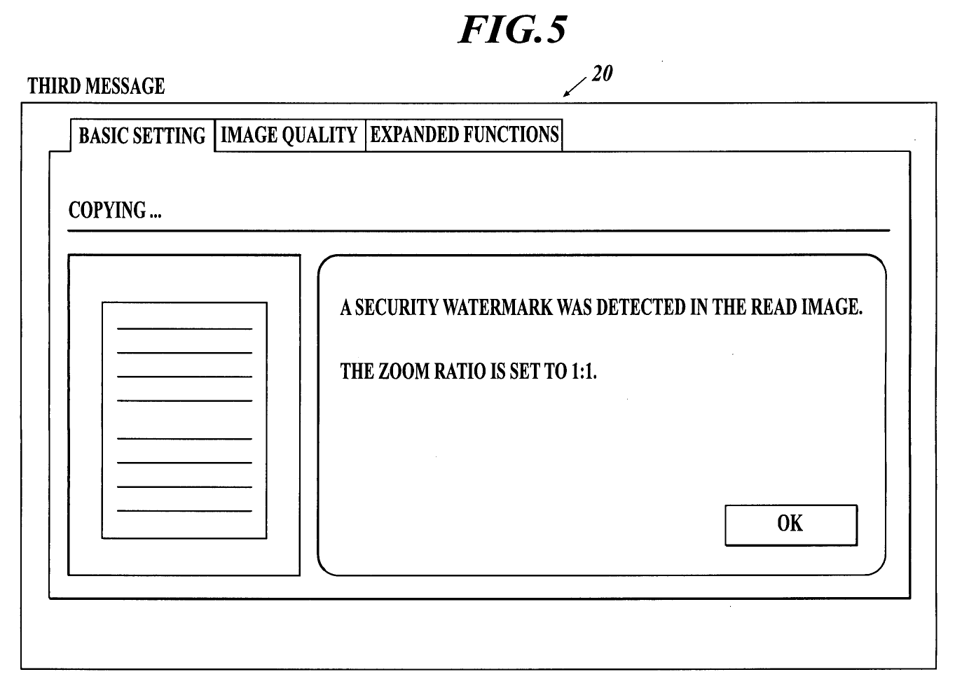

The display panel unit 20 is a section composed of a heretofore known liquid crystal panel or the like. The display panel unit 20 is configured to perform a display based on the transmission content in accordance with a signal transmitted from the control unit 50. The display panel unit 20 is configured to, for example, display the situation at the time of reading an original image (see FIG. 3), the situation during copying the original image (see FIGS. 4 and 5), and the like, as shown in FIGS. 3-5.

The scanner unit 30 is a section composed of a heretofore known scanner. The scanner unit 30 is configured to read an original image and generate the image data of the original image based on the result of the reading, and then to transmit the image data to the control unit 50.

In addition, the scanner unit 30 is equipped with a reducing optical system. The scanner unit 30 is configured to reduce the original image with the reducing optical system, and to form the image of the original image on a CCD image sensor at the time of copying the original image. The image forming apparatus 1 is configured so that the reduction ratio of the reducing optical system may be constantly independent of a zoom ratio of copying, and that an alteration of the zoom ratio may be realized by the thinning-out processing (at the time of setting reduction) or interpolation processing (at the time of setting expansion) of the image data generated by the scanner unit 30 by the control unit 50. Consequently, the image forming apparatus 1 is configured so that the “reading resolution” for reading an original image with the scanner unit 30 may be always constant.

The printer unit 40 is a section composed of a heretofore known laser printer or the like. The printer unit 40 is configured to record an image on a recording medium based on the transmitted content in accordance with a signal transmitted from the control unit 50, and to output the recording medium as a copy.

The control unit 50 is a section composed of a heretofore known central processing unit (CPU), a random access memory (RAM), a read only memory (ROM) and the like. The control unit 50 is configured so that various kinds of data, processing programs and the like may be stored in the ROM, and that the CPU may use the RAM as a work area while executing the processing in accordance with the processing program in the ROM.

The control unit 50 is configured, for example, to receive a signal from the operation panel unit 10 and control the operation of the scanner unit 30 and the printer unit 40 under the condition based on the received signal, to receive a signal from the operation panel unit 10 and make the display panel unit 20 display the contents based on the received signal, and to receive image data from the scanner unit 30 and make the printer unit 40 execute the copying operation based on the received image data.

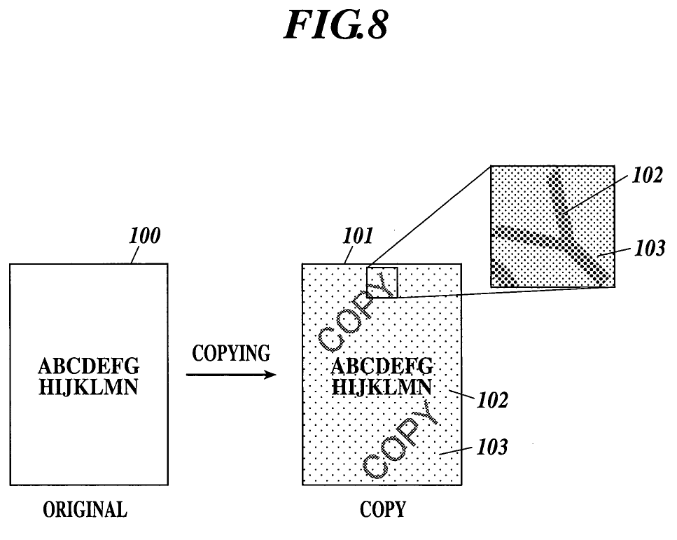

In particular, the control unit 50 is configured so that the ROM may include registered (stored) many security watermark patterns in advance, and that the CPU may perform the pattern matching processing between the registered patterns and the security watermark (corresponding to the concealed text 102 and the pattern 103 in FIG. 8) of the original image read with the scanner unit 30 to be able to detect whether there is any security watermark or not in the original image.

Furthermore, the control unit 50 has set “outputting resolution”, which is the resolution for the printer unit 40 to output an image onto a recording medium, therein as an initial value in advance. The control unit 50 is configured so as to make the printer unit 40 output an image to the recording medium based on the outputting resolution in principle unless the condition at the time of copying by the operation panel unit 10 is changed.

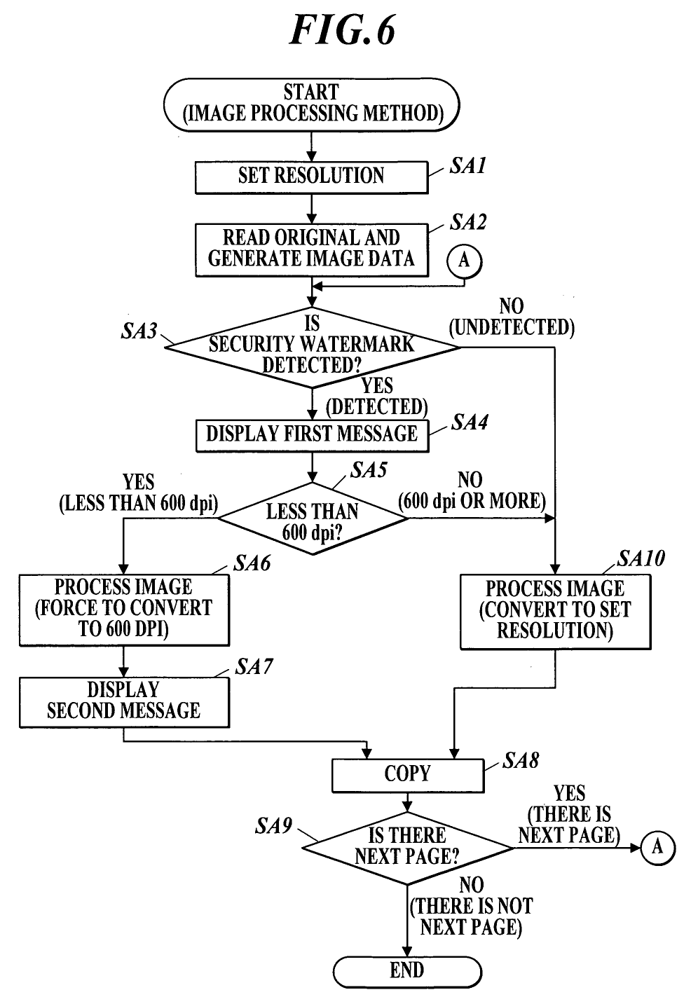

Next, the image processing method according to the present embodiment is described with reference to FIG. 6.

A user sets the outputting resolution by an operation of the operation panel unit 10 before the copying of an original image by the image forming apparatus 1 (Step SA1, setting step).

In this case, when the user operates the operation panel unit 10 to set the outputting resolution, the content thereof is transmitted to the control unit 50 as a signal, and the control unit 50 recognizes the fact.

After that, when the user operates the operation panel unit 10 and then a signal indicating the start of the copying of the original image is transmitted to the control unit 50, the control unit 50 recognizes the fact to make the scanner unit 30 read the original image to generate image data (Step SA2).

In this case, the scanner unit 30 generates image data of the original image from the result of reading of the original image by the scanner unit 30 every reading thereof by the scanner unit 30 (generation step), and the scanner unit 30 transmits the read image data to the control unit 50.

In addition, the processing at the Step SA1 may be omitted. In this case, the control unit 50 recognizes the outputting resolution as the initial value set in advance, and executes the processing at and after the Step SA2.

After that, the control unit 50 judges whether there is a security watermark in the original image or not based 4on the image data transmitted from the scanner unit 30 (Step SA3, judgment step).

To put it concretely, the control unit 50 judges whether there is a repetition patter (a dot pattern appearing repeatedly) in the original image or not. When the control unit 50 recognizes that there is the repetition pattern, it further judges whether the repetition pattern agrees with a registered pattern or not.

When the control unit 50 recognizes that there is the repetition pattern in the original image, and that the repetition pattern agrees with the registered pattern as a result of the judgment at the Step SA3, the control unit 50 recognizes that there is the security watermark in the original image, and executes the processing at Step SA4.

In addition, at the processing at the Step SA3, the control unit 50 may not judge whether the repetition pattern agrees with the registered pattern or not, and may recognize that there is the security watermark in the original image at the time point when the control unit 50 recognizes that there is the repetition pattern in the original image. Alternatively, the control unit 50 may judge that there is the security watermark in the original image at the time point when the control unit 50 identifies large dots and small dots in the original image to recognize the concealed text of the security watermark (corresponding to the concealed text 102 in FIG. 8) based on the contours of the large dots.

In the processing at the Step SA4, the control unit 50 makes the display panel unit 20 display a first message indicating the fact that the security watermark has been detected in the original image in a display mode shown in FIG. 3.

In this case, the display panel unit 20 displays the first message indicating the fact that the security watermark has been detected in the original image in the display mode shown in FIG. 3 (display step).

After that, the control unit 50 judges whether the outputting resolution set by the processing at the Step SA1 is less than 600 dpi or not (Step SA5).

When the control unit 50 recognizes that the outputting resolution is less than 600 dpi as the result of the judgment at the Step SA5, the control unit 50 performs image processing (interpolation processing) to the image data so that the number of pixels may be the one agreeing with 600 dpi (Step SA6).

That is, in the processing at the Step SA6, the control unit 50 is configured so as to forcibly convert (reset) the outputting resolution to 600 dpi independent of the outputting resolution set by the processing at the Step SA1, and to prohibit the reduce of the number of the pixels of the image data to be a predetermined value or less (prohibition step).

The forcible conversion of the outputting resolution to 600 dpi is performed in order to prevent the loss of the information of the security watermark in the original image owing to the reduce of the number of the pixels of the image data to the predetermined value or less, and the forcible conversion is performed because the outputting resolution up to which the information of the security watermark is not lost is about 600 dpi.

After that, the control unit 50 makes the display panel unit 20 display the fact of the forcible conversion of the outputting resolution to 600 dpi (Step SA7).

In this case, the display panel unit 20 displays a second message indicating the fact of the forcible conversion of the outputting resolution to 600 dpi in the display mode shown in FIG. 4.

After that, the control unit 50 makes the printer unit 40 copy the content of the original image at the forcibly converted outputting resolution (Step SA8).

In this case, the printer unit 40 records the original image read by the scanner unit 30 at 600 dpi based on the image data, and outputs the recording medium as a copy (output step).

After that, the control unit 50 judges whether there is the next page in the original or not based on the image data (Step SA9). When the control unit 50 recognizes that there is the next page as the result of the judgment, the control unit 50 again executes the processing at and after the Step SA3. On the other hand, when the control unit 50 recognizes that there is not the next page, the control unit 50 ends the copying control processing.

In addition, when the control unit 50 recognizes that there are no repetition patterns in the original image, or when the control unit 50 recognizes that there is a repetition pattern in the original image but the repetition pattern does not agree with any one of the registered patterns, as the result of the judgment at the Step SA3, the control unit 50 recognizes that the original image does not have any security watermarks to execute the processing at Step SA10.

Also when the control unit 50 recognizes that the outputting resolution set at the Step SA1 is 600 dpi or more as the result of the judgment at the Step SA5, the control unit 50 executes the processing at the Step SA10.

In the processing at the Step SA10, the control unit 50 performs image processing to the image data according to the outputting resolution set by the processing at the Step SA1.

To put it more concretely, the control unit 50 performs the thinning-out processing or the interpolation processing of the image data so that the number of pixels of the image data may become the number of pixels according to the outputting resolution set at the Step SA1.

In the processing at the Step SA8 after that, the control unit 50 executes the processing of making the printer unit 40 copy the content of the original image at the outputting resolution set in the processing at the Step SA1, and the printer unit 40 receives the processing to record the original image read with the scanner unit 30 onto the recording medium at the outputting resolution set in the processing at the Step SA1. Then, the printer unit 40 outputs the recording medium as a copy (output step).

In the first embodiment mentioned above, when a security watermark is detected in an original image in the processing at the Step SA3, the outputting resolution at the time of copying is necessarily set to be constant (600 dpi) by each processing at the Steps SA5 and SA6. Consequently, when the security watermark is detected in the original image, the occurrence of the copying of the original image in the state of low outputting resolution can be previously prevented, and forgery copying can be surely prevented even if copying is repeated.

### Second Embodiment

The present second embodiment differs from the first embodiment in the following respects, and has the same configuration as that of the first embodiment in the other respects.

In an image processing method according to the second embodiment, a user sets a zoom ratio (any of reduction, the same scale, and expansion) at the time of copying by an operation of the operation panel unit 10 before the copying of an original image with the image forming apparatus 1 (Step SB1, setting step).

In this case, when the user sets the zoom ratio at the time of copying by operating the operation panel unit 10, the content is transmitted to the control unit 50 as a signal, and the control unit 50 recognizes the fact.

After that, when a signal indicating the start of the copying of the original image is transmitted to the control unit 50 by an operation of the operation panel unit 10 by the user, the control unit 50.recognizes the fact, and makes the scanner unit 30 read the original image to generate the image data of the original image (Step SB2).

In this case, whenever the scanner unit 30 reads the original image, the scanner unit 30 generates the image data of the original image based on the reading result (generation step), and transmits the generated image data to the control unit 50.

After that, the control unit 50 executes the pieces of processing similar to those at the Steps SA3 and SA4 in FIG. 6 (Step SB3 (judgment step), Step SB4 (display step)).

After that, the control unit 50 judges whether the zoom ratio at the time of the copying, which zoom ratio has been set at the Step SB1, is the reduction or not (Step SB5).

When the control unit 50 recognizes that the zoom ratio is the reduction as the result of the judgment at the Step SB5, the control unit 50 performs the image processing in accordance with the setting of the same scale to the image data so that the number of pixels of the image data may be that of the same scale (Step SB6).

That is, in the processing at the Step SB6, the control unit 50 is configured so as to forcibly set the zoom ratio at the time of copying to the same scale independent of the zoom ratio at the time of copying which zoom ratio has been set in the processing at the Step SB1, and to prohibit the reduce of the number of pixels of the image data to be the predetermined value or less (prohibition step).

It is because of preventing the loss of the information of the security watermark in the original image which loss has been caused by the reduce of the number of pixels of the image data that the zoom ratio at the time of the copying is forcibly set to the same scale.

After that, the control unit 50 makes the display panel unit 20 display the fact that the zoom ratio at the time of the copying is forcibly set to the same scale (Step SB7).

In this case, the display panel unit 20 displays a third message indicating the fact that the zoom ratio at the time of the copying is forcibly converted to the same scale in the display mode shown in FIG. 5.

After that, the control unit 50 makes the printer unit 40 copy the content of the original image by the same scale, which has been forcibly set (Step SB8).

In this case, the printer unit 40 records the original image, which has been read by the scanner unit 30 based on the image data, by the same scale onto a recording medium, and outputs the recording medium as a copy (output step).

After that, the control unit 50 judges whether there is the next page in the original or not based on the image data (Step SB9). When the control unit 50 recognizes that there is the next page as the result of the judgment, the control unit 50 again executes the processing at and after the Step SB3. On the other hand, when the control unit 50 recognizes that there is not the next page, the control unit 50 ends the copying control processing.

In addition, the control unit 50 executes the processing at Step SB10 when the control unit 50 recognizes that there are no security watermarks in the original image as the result of the judgment at the Step SB3, or when the control unit 50 recognizes that the zoom ratio at the copying, which has been set at the Step SB1, is the same scale or the expansion as the result of the judgment at the Step SB5.

In the processing at the Step SB10, the control unit 50 performs the image processing of the image data according to the zoom ratio set by the processing at the Step SB1.

To put it more concretely, the control unit 50 performs the image processing to the image data so that the number of the pixels of the image data may be the one corresponding to the zoom ratio set at the time of the copying, which zoom ratio has been set by the processing at the Step SB1. When the zoom ratio at the time of the copying has been set to the reduction in the processing at the Step SB1, the control unit 50 performs the thinning-out processing to the image data. When the zoom ratio at the time of the copying has been set to the same scale in the processing at the Step SB1, the control unit 50 performs the image processing to the image data in accordance with the same scale setting. When the zoom ratio at the time of the copying has been set to the expansion in the processing at the Step SB1, the control unit 50 performs the interpolation processing to the image data.

In the processing at Step SB8 after that, the control unit 50 executes the processing of making the printer unit 40 copy the content of the original image on the zoom ratio set in the processing at the Step SB1, and the printer unit 40 receives the instruction of the control unit 50 to record the original image read with the scanner unit 30 onto the recording medium on the zoom ratio set by the processing at the Step SB1. Then, the printer unit 40 outputs the recording medium as a copy (output step).

In the second embodiment mentioned above, when a security watermark is detected in an original image in the processing at the Step SB3, the zoom ratio at the time of copying is necessarily set to the same scale by each processing at the Steps SB5 and SB6. Consequently, when the security watermark is detected in the original image, it can be previously prevented to perform the copying by a reduced zoom ratio, and forgery copying can be surely prevented even if copying is repeated.

In addition, the present invention is not limited to the first and the second embodiments, and various improvements and alterations of design may be performed without departing from the scope of the present invention.

As an item of the improvements and the alterations of design, the resolution other than 600 dpi may be applied to the pieces of processing at the Steps SA5 and SA6 of FIG. 6, and the resolution may be less than 600 dpi, or larger than 600 dpi.

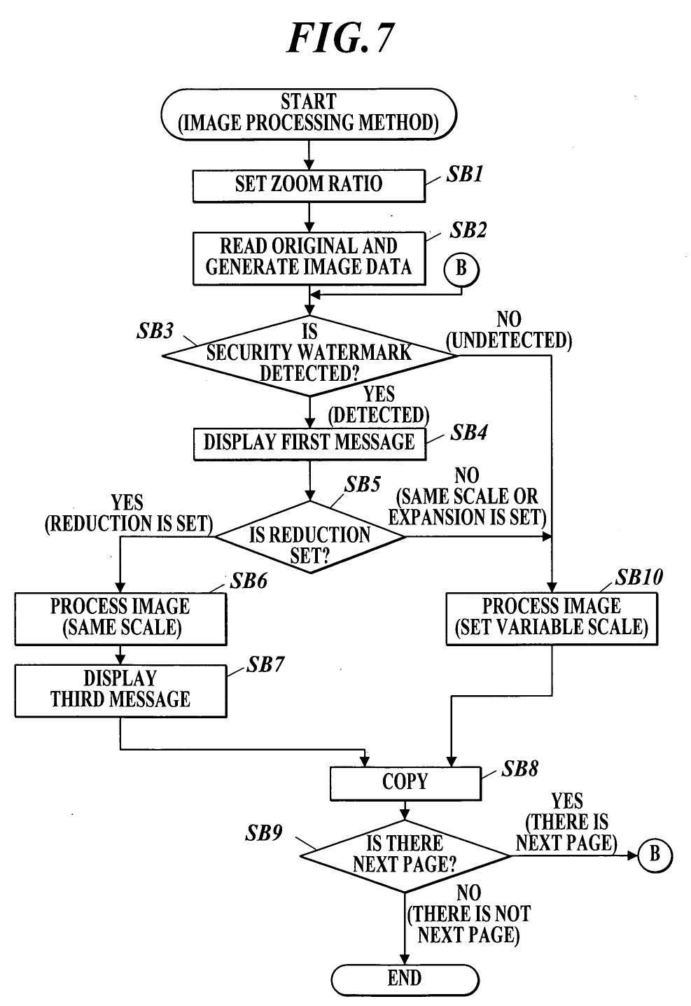

As another item of the improvements and the alterations of design, the control unit 50 may omit the pieces of processing at the Step SA5 of FIG. 6 and the Step SB5 of FIG. 7, and may execute the pieces of processing at the Steps SA6 and SB6 immediately after the end of the pieces of processing at the Steps SA5 and SB5, respectively.

As a further item of the improvements and the alterations of design, the image forming apparatus 1 may be configured so that, in the pieces of processing at the Step SA8 of FIG. 6 and the Step SB8 of FIG. 7, the control unit 50 may deliver the image data after the pieces of processing at the Step SA6 of FIG. 6 and the Step SA10 of FIG. 7, respectively, to an external device other than the image forming apparatus 1.

What is claimed is:

1. An image forming apparatus, comprising:
a scanner unit to read an original image to generate image data; and
a control unit to judge whether there is a security watermark in the original image or not based on the image data, and to prohibit reducing the number of pixels of the image data to a predetermined value or less when the control unit recognizes a presence the security watermark in the original image.

2. The apparatus according to claim 1, further comprising: a display panel unit to display the presence of the security watermark in the original image.

3. The apparatus according to claim 1, further comprising: a printer unit to record an image on a recording medium based on the image data to output the recording medium as a copy.

4. The apparatus according to claim 1, further comprising: a setting unit to set resolution, wherein
the control unit prohibits reducing the number of pixels of the image data to the predetermined value or less independent of the resolution set by the setting unit when the control unit recognizes that there is the security watermark in the original image.

5. The apparatus according to claim 1, further comprising: a setting unit to set a zoom ratio of copying,
wherein the control unit prohibits reducing the number of pixels of the image data to the predetermined value or less independent of the zoom ratio set by the setting unit when the control unit recognizes that there is the security watermark in the original image.

6. An image processing method, comprising the steps of:
reading an original image to generate image data;
judging whether there is a security watermark in the original image or not based on the image data; and
prohibiting reducing the number of pixels of the image data to a predetermined value or less when a presence of the security watermark is recognized in the original image.

7. The method according to claim 6, further comprising the step of: displaying the presence of the security watermark in the original image when the presence of the security watermark is recognized in the original image.

8. The method according to claim 6, further comprising the step of: recording an image on a recording medium based on the image data to output the recording medium as a copy.

9. The method according to claim 6, further comprising the step of: setting resolution,
wherein in the prohibiting step, reducing the number of pixels of the image data to the predetermined value or less is prohibited independent of the resolution set in the setting step when it is recognized that there is the security watermark in the original image.

10. The method according to claim 6, further comprising the step of: setting a zoom ratio of copying,
wherein in the prohibiting step, reducing the number of pixels of the image data to the predetermined value or less is prohibited independent of the zoom ratio set in the setting step when it is recognized that there is the security watermark in the original image.
